(19) United States
(12) Patent Application Publication
(10) Pub. No.: US 2007/0271839 A1
(43) Pub. Date: Nov. 29, 2007

(54) Electronic mosquito racket

(76) Inventor: Kuei-Tzu Su, Taichung County (TW)

Correspondence Address: BROWDY AND NEIMARK, P.L.L.C.;624 NINTH STREET, NW, SUITE 300, WASHINGTON, DC, 20001-5303, US

(21) Appl. No.: 11/712,528

(22) Filed: Mar. 1, 2007

(30) Foreign Application Priority Data
May 29, 2006 (TW) 95209296

(51) Int. Cl. A01M 3/02; A01M 3/00; A01M 1/22

(52) U.S. Cl. 43/112

(57) ABSTRACT

An electronic mosquito racket includes a frame body holding a charged mesh, a grip accommodating a power control unit that is electrically connected to the charged mesh, and a shaft made out of a flexible material and connected between the frame body and the grip to enhance the swiping speed of the electronic mosquito racket and to provide a shock absorbing effect.

### BACKGROUND OF THE INVENTION

1. Field of the Invention

The present invention relates apparatus for killing insects and more particularly, to an electronic mosquito racket, which enhances the swiping speed and provides a shock absorbing effect.

2. Description of the Related Art

A regular electronic mosquito racket generally comprises a frame body, a grip, and a shaft. The frame body holds a charged mesh on the inside. The grip houses a battery, which is electrically connected to the charged mesh, and an on/off switch, which controls electrical connection between the battery and the charged mesh. The shaft is a hard rod member connected between the frame body and the grip. When the user presses on the on/off switch, an electric current goes through the charged mesh to kill insects that touch the charged mesh.

However, because the shaft of the aforesaid electronic mosquito racket is a hard rod member, the speed of the swiping motion of the electronic mosquito racket is not fast enough, and the operation angle will be limited, so the insects may escape before touching the charged mesh. Further, when the user swiping the electronic mosquito racket to kill insects staying on a wall, shocks produced when the frame body touches the wall will be transmitted to the user's hand. At this time, the shaft may be damaged, or the user's hand may feel uncomfortable. Therefore, this prior art design is not satisfactory in function.

### SUMMARY OF THE INVENTION

The present invention has been accomplished under the circumstances in view. The one object of the present invention is to provide an electronic mosquito racket, which enhances the swiping speed and operation angle. It is another object of the present invention to provide an electronic mosquito racket, which provides a shock absorbing effect.

To achieve these objects of the present invention, the mosquito racket comprises a frame body holding a charged mesh, a grip accommodating a power control unit that is electrically connected to the charged mesh, and a shaft made out of a flexible material and connected between the frame body and the grip.

### BRIEF DESCRIPTION OF THE DRAWINGS

FIG. 1 is a front view of an electronic mosquito racket in accordance with the present invention.

FIG. 2 is a side view of the electronic mosquito racket in accordance with the present invention.

FIG. 3 is a schematic drawing showing an application example of the present invention.

FIG. 4 is a schematic drawing showing another application example of the present invention.

### DETAILED DESCRIPTION OF THE INVENTION

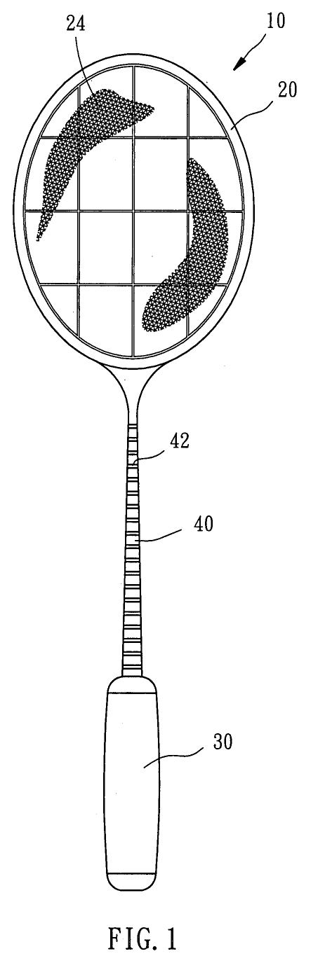

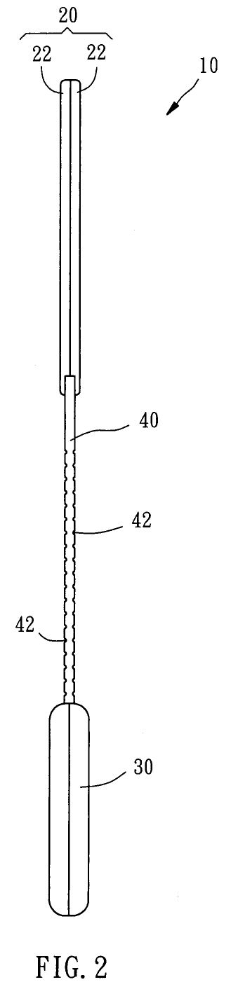

Referring to FIGS. 1 and 2, an electronic mosquito racket 10 in accordance with the present invention is shown comprising a frame body 20, a grip 30, and a shaft 40.

The frame body 20 comprises two open frames 22 arranged in a stack, and an internal charged mesh 24 set within the open frames 22.

The grip 30 is a hollow member for enabling the user to grasp with the hand. The grip 30 houses a power control unit, which comprises a battery set (not shown) and an on/off switch (not shown) for control electrical connection between the battery set and the internal charged mesh 24 of the frame body 20.

The shaft 40 is a flexible member made out of plastics, rubber, carbon fibers, or any other suitable materials. According to the present preferred embodiment, the shaft 40 is molded from plastics, having one end fixedly connected to the frame body 20 and the other end fixedly connected to one end of the grip 30. Further, the shaft 40 houses an electric circuit (not shown) that is electrically connected between the internal charged mesh 24 and the battery set in the grip 30. Further, the shaft 40 has a plurality of grooves 42 extending around the periphery and spaced along the length of the shaft 40 to enhance the flexibility of the shaft 40.

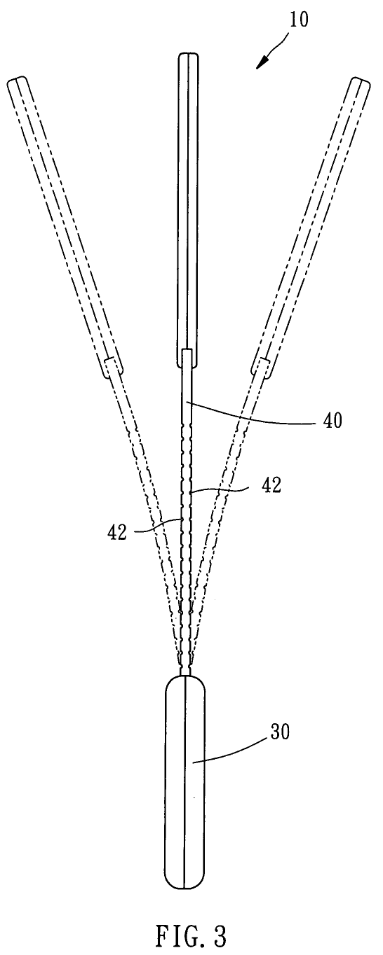

Referring to FIG. 3, when using the electronic mosquito racket 10 to kill insects, hold the grip 30 with the hand and press on the switch to power the internal charged mesh by electric current, and move the electronic mosquito racket 10 to hit bugs, flies, mosquitoes, and harmful insects. Because the shaft 40 is a flexible rod member, operate the electronic mosquito racket 10 with a swiping motion causes the shaft 40 to vibrate, enhancing the swiping speed. Further, the grooves 42 around the periphery of the shaft 40 enhance the flexibility of the shaft 40.

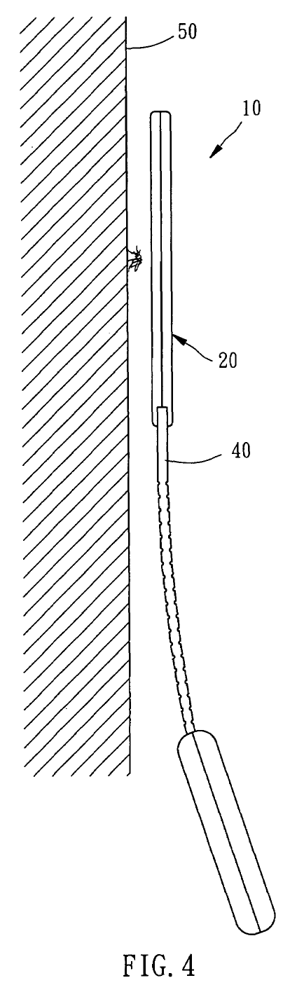

Referring to FIG. 4, when an insect is staying on a wall 50, the user must move the electronic mosquito racket 10 toward the wall 50. When the open frames 22 of the frame body 20 touch the wall 50, the shaft 40 will be curved to absorb shocks, preventing damage to the shaft 40 or potential injury of the hand.

In general, the invention provides an electronic mosquito racket, which has a flexible shaft that enhances the swiping speed and provides a shock absorbing effect.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. An electronic mosquito racket comprising
a frame body, said frame body holding a charged mesh;
a grip, said grip accommodating a power control unit that is electrically connected to said charged mesh; and
a shaft connected between said frame body and said grip, said shaft being made out of a flexible material.

2. The electronic mosquito racket as claimed in claim 1, wherein said flexible material is a plastic material.

3. The electronic mosquito racket as claimed in claim 1, wherein said flexible material is rubber.

4. The electronic mosquito racket as claimed in claim 1, wherein said flexible material is carbon fibers.

5. The electronic mosquito racket as claimed in claim 1, wherein said shaft has a plurality of grooves extending around the periphery and spaced along the length thereof.
